(19) United States
(12) Patent Application Publication
(10) Pub. No.: US 2014/0285381 A1
(43) Pub. Date: Sep. 25, 2014

(54) ANTENNA STRUCTURE

(71) Applicant: Chiun Mai Communication Systems, Inc., New Taipei (TW)

(72) Inventors: YI-CHIEH LEE, New Taipei (TW); YEN-HUI LIN, New Taipei (TW)

(73) Assignee: Chiun Mai Communication Systems, Inc., New Taipei (TW)

(21) Appl. No.: 14/014,610

(22) Filed: Aug. 30, 2013

(30) Foreign Application Priority Data
Mar. 20, 2013 (TW) 102109763

(51) Int. Cl. H01Q 9/04

(52) U.S. Cl. CPC H01Q 9/04
USPC 343/700 MS

(57) ABSTRACT

An antenna structure includes a feed portion, a first radiating body, and a resonating section. The first radiating body includes first and second shared sections, and first, second, and third extending sections. The resonating section and the first shared section are connected to the feed portion and on receiving feed signals. The first radiating body achieves a first required frequency band. The first shared section and the resonating section together resonate at a second required frequency band. The first shared section and the second shared section together resonate at a third required frequency band.

### BACKGROUND

1. Technical Field

The disclosure generally relates to antenna structures and particularly to an antenna structure having a wider bandwidth.

2. Description of Related Art

To communicate in multi-band communication systems, a bandwidth of an antenna of a wireless communication device such as a mobile phone needs to be wide enough to cover frequency bands of the multi-band communication systems. In addition, because of the miniaturization of the wireless communication device, space available for the antenna is reduced and limited. Therefore, it is necessary to design the antenna to have the wider bandwidth within reduced and limited spaces.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is a schematic view of an antenna structure, according to an exemplary embodiment.

FIG. 2 is similar to FIG. 1, but viewed from another angle.

FIG. 3 is a diagram showing return loss measurements of the antenna structure shown in FIG. 1.

### DETAILED DESCRIPTION

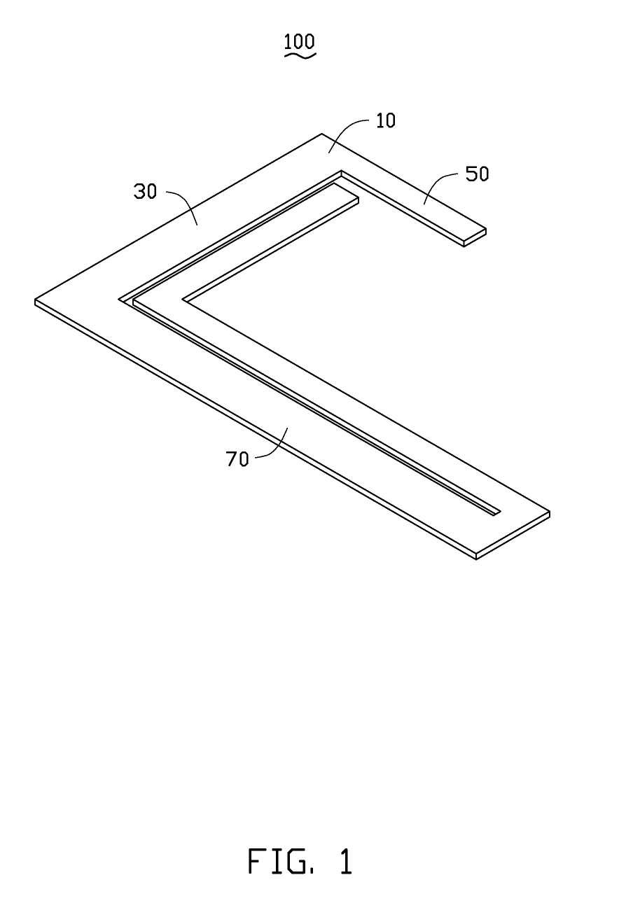

FIG. 1 is a schematic view of an antenna structure 100, according to an exemplary embodiment. The antenna structure 100 is for use in a wireless communication device (not shown), such as a mobile phone, a personal digital assistant, or a laptop computer.

The antenna structure 100 includes a feed portion 10, a first radiating body 30, a second radiating body 50, and a third radiating body 70.

The feed portion 10 is electronically connected to a feed terminal of a printed circuit board of the wireless communication device (not shown), which feeds current for the antenna structure 100.

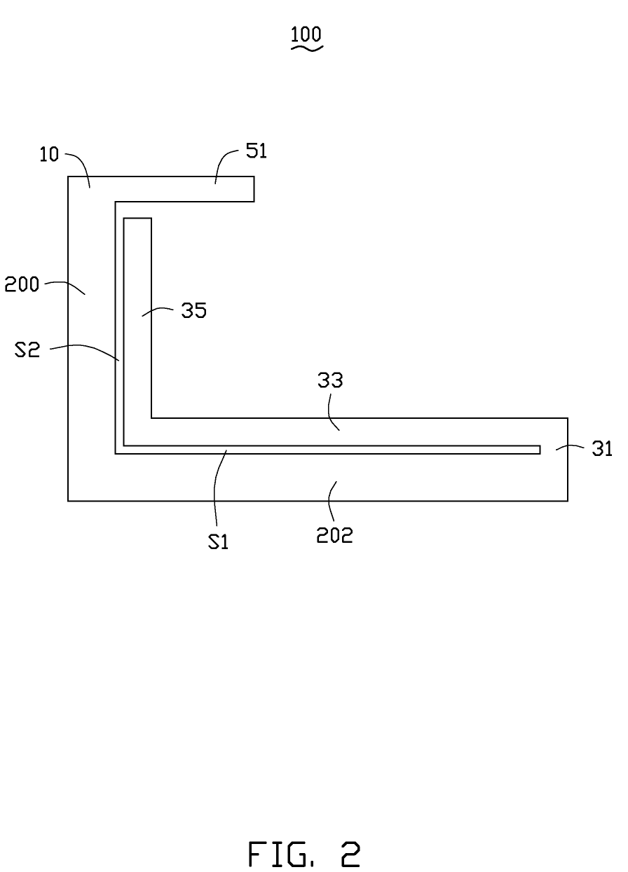

FIG. 2 shows that the first radiating body 30 includes a first shared section 200, a second shared section 202, a first extending section 31, a second extending section 33, and a third extending section 35 connected in that order. In this exemplary embodiment, the first shared section 200, the second shared section 202, the first extending section 31, the second extending section 33, and the third extending section 35 are coplanar. The first shared section 200 is substantially strip-shaped. The first shared section 200 is perpendicularly connected to the feed portion 10 and extends away from the feed portion 10. The second shared section 202 is substantially strip-shaped. The second shared section 202 has one end perpendicularly connected to a distal end of the first shared section 202 away from the feed portion 10 and another end perpendicularly connected to the first extending section 31.

The first extending section 31 is parallel to the first shared section 200 and is perpendicularly connected to a distal end of the second shared section 202 away from the first shared section 200. The first extending section 31 extends towards the feed portion 10.

The second extending section 33 is substantially strip-shaped. The second extending section 33 is parallel to the second shared section 202 and is perpendicularly connected to a distal end of the first extending section 31 away from the second shared section 202. The second extending section 33 extends towards the first shared section 200. The second shared section 202, the first extending section 31 and the second extending section 33 are spaced apart and therefore cooperatively form a first slot S1 between them.

The third extending section 35 is substantially strip-shaped. The third extending section 35 is perpendicularly connected to a distal end of the second extending section 33 away from the first extending section 31, extends towards the feed portion 10, and is parallel to the first shared section 200. The third extending section 35 and the first shared section 200 are spaced apart and therefore cooperatively form a second slot S2 between them. By varying a length of the first radiating body 30 and the respective sizes of the first slot S1 and the second slot S2, the antenna structure 100 can achieve a first required frequency band (e.g., a frequency band of global positioning system). In this exemplary embodiment, a central frequency of the first required frequency band is about 1575 MHz.

The second radiating body 50 includes the first shared section 200 and a resonating section 51. The resonating section 51 and the first shared section 200 are coplanar. The resonating section 51 is substantially strip-shaped. The resonating section 51 is electronically connected to the feed portion 10, extends towards the first extending section 31, and is parallel to the second extending section 33. The resonating section 51 is spaced from the third extending section 35. When current from the feed portion 10 flows through the resonating section 51 and the first shared section 200, the resonating section 51 and the first shared section 200 generate a resonance, thereby rendering the antenna structure 100 receptive to a second required frequency band (e.g., a frequency band of wireless local area network). In this exemplary embodiment, a central frequency of the second required frequency band is about 5230 MHz.

The third radiating body 70 includes the first shared section 200 and the second shared section 202. When current from the feed portion 10 flows through the first shared section 200 and the second shared section 202, the first shared section 200 and the second shared section 202 generate a resonance, thereby rendering the antenna structure 100 receptive to a third required frequency band. In this exemplary embodiment, a central frequency of the third required frequency band is about 2450 MHz.

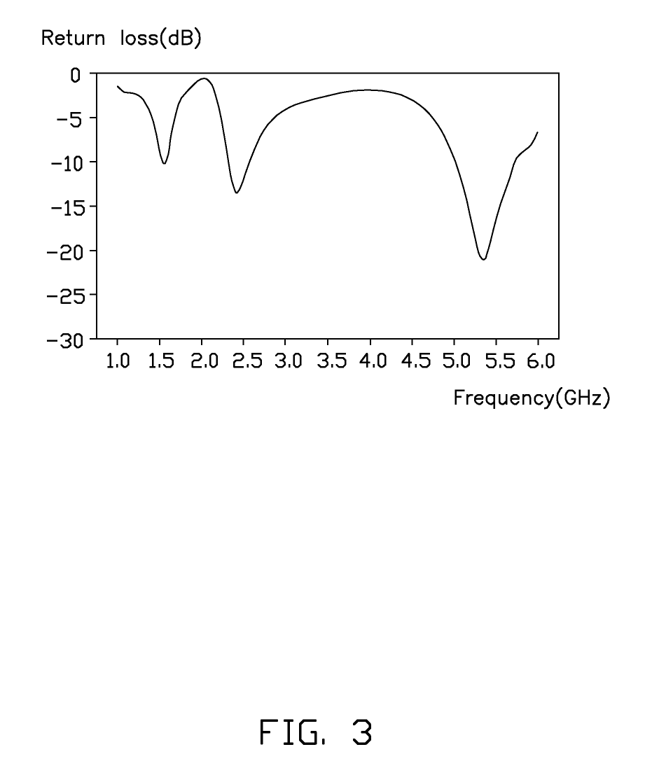

Referring to FIG. 3, when the antenna structure 100 is used, a feed signal input from the printed circuit board of the wireless communication device can be passed to the first shared section 200, the second shared section 202, the first extending section 31, the second extending section 33, and the third extending section 35 to activate a first resonance mode for receiving and sending wireless signals of the first required frequency band. Simultaneously, the resonating section 51 and the first shared section 200 are driven to resonate due to current flowing through the resonating section 51 and the first shared section 200, and a second resonance mode is generated for receiving and sending wireless signals of the second required frequency band. In addition, the first shared section 200 and the second shared section 202 are driven to resonate due to current flowing through first shared section 200 and the second shared section 202, and a third resonance mode is generated for receiving and sending wireless signals of the third required frequency band. Thus, the antenna structure 100 can transmit and receive wireless signals of multiple frequency bands and has a widened bandwidth.

The antenna structure 100 includes a plurality of radiating bodies, and the first shared section 200 and the resonating section 51 can cooperatively create a new resonance mode so that a bandwidth of the antenna structure 100 is widened. In addition, the first radiating body 30 and the second radiating body 50 share the first shared section 200, and the first radiating body 30 and the third radiating body 70 share the first shared section 200 and the second shared section 202, so that the entire volume of the antenna structure 100 is reduced.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An antenna structure, comprising:
a feed portion;
a first radiating body comprising a first shared section, a second shared section, a first extending section, a second extending section, and a third extending section connected in that order, the first shared section connected to the feed portion; and
a resonating section connected to the feed portion; wherein when a feed signal is input to the feed unit, the first radiating body achieves a first frequency band, the first shared section and the resonating section together resonate at a second frequency band, the first shared section and the second shared section together resonate at a third frequency band.

2. The antenna structure of claim 1, wherein the first shared section, the second shared section, the first extending section, the second extending section, the third extending section, and the resonating section are coplanar.

3. The antenna structure of claim 1, wherein the first shared section is perpendicularly connected to the feed portion and extends away from the feed portion, the second shared section has one end perpendicularly connected to a distal end of the first shared section away from the feed portion and another end perpendicularly connected to the first extending section.

4. The antenna structure of claim 3, wherein the first extending section is perpendicularly connected to a distal end of the second shared section away from the first shared section, extends towards the feed portion, and is parallel to the first shared section; the second extending section is connected to a distal end of the first extending section away from the second shared section, extends towards the first shared section, and is parallel to the second shared section.

5. The antenna structure of claim 4, wherein the second shared section, the first extending section, and the second extending section are spaced apart and therefore cooperatively form a first slot between them.

6. The antenna structure of claim 1, wherein the third extending section is perpendicularly connected to a distal end of the second extending section away from the first extending section, extends towards the feed portion, and is parallel to the first shared section.

7. The antenna structure of claim 6, wherein the third extending section and the first shared section are spaced apart and therefore cooperatively form a second slot between them.

8. The antenna structure of claim 1, wherein the resonating section extends towards the first extending section, is parallel to the second extending section and is spaced from the third extending section.

9. The antenna structure of claim 1, wherein a central frequency of the first frequency band is about 1575 MHz, a central frequency of the second frequency band is about 5230 MHz, and a central frequency of the third frequency band is about 2450 MHz.

10. An antenna structure, comprising:
a feed portion;
a first radiating body comprising a first shared section, a second shared section, a first extending section, a second extending section, and a third extending section connected in that order, the first shared section connected to the feed portion;
a second radiating body comprising the first shared section and a resonating section connected to the feed portion; and
a third radiating body comprising the first shared section and the second shared section; wherein when a feed signal is input to the feed unit, the first radiating body receives and sends wireless signals of a first frequency band, the second radiating body receives and sends wireless signals of a second frequency band, and the third radiating body receives and sends wireless signals of a third frequency band.

11. The antenna structure of claim 10, wherein the first shared section, the second shared section, the first extending section, the second extending section, the third extending section, and the resonating section are coplanar.

12. The antenna structure of claim 10, wherein the first shared section is perpendicularly connected to the feed portion and extends away from the feed portion, the second shared section has one end perpendicularly connected to a distal end of the first shared section away from the feed portion and another end perpendicularly connected to the first extending section.

13. The antenna structure of claim 12, wherein the first extending section is perpendicularly connected to a distal end of the second shared section away from the first shared section, extends towards the feed portion, and is parallel to the first shared section;
the second extending section is connected to a distal end of the first extending section away from the second shared section, extends towards the first shared section, and is parallel to the second shared section.

14. The antenna structure of claim 13, wherein the second shared section, the first extending section, and the second extending section are spaced apart and therefore cooperatively form a first slot between them.

15. The antenna structure of claim 10, wherein the third extending section is perpendicularly connected to a distal end of the second extending section away from the first extending section, extends towards the feed portion, and is parallel to the first shared section.

16. The antenna structure of claim 15, wherein the third extending section and the first shared section are spaced apart and therefore cooperatively form a second slot between them.

17. The antenna structure of claim 10, wherein the resonating section extends towards the first extending section, is parallel to the second extending section and is spaced from the third extending section.

18. The antenna structure of claim 10, wherein a central frequency of the first frequency band is about 1575 MHz, a central frequency of the second frequency band is about 5230 MHz, and a central frequency of the third frequency band is about 2450 MHz.
